(19) United States
(12) Patent Application Publication
(10) Pub. No.: US 2017/0000111 A1
(43) Pub. Date: Jan. 5, 2017

(54) METHOD AND APPARATUS FOR COOLING WITHOUT FREEZING

(71) Applicant: MAG SOAR SL, Madrid (ES)

(72) Inventors: José Luis Pérez Díaz, Madrid (ES); Marco Álvarez Valenzuela, Madrid (ES); Juan Sánchez-García Casarrubios, Madrid (ES)

(21) Appl. No.: 15/113,037

(22) PCT Filed: Jan. 19, 2015
(86) PCT No.: PCT/EP2015/050883

§ 371 Date: Jul. 20, 2016

(30) Foreign Application Priority Data
Jan. 20, 2014 (EP) 14151839.9

(51) Int. Cl. A01N 1/02; F25D 17/04; F25B 21/02

(52) U.S. Cl. CPC A01N 1/0284; A01N 1/0252; F25B 21/02; F25D 17/042; F25D 2317/04111; F25D 2317/04131

(57) ABSTRACT

The present invention discloses a method for modulating freezing of a liquid substance, said liquid substance being in the presence of a gas phase, the method comprising modulating the temperature of the liquid substance, of the gas phase or of both, and controlling the concentration of vapor of the substance present in the gas phase. The invention further comprises a method for preservation, for example, food or other biological material, and an apparatus for putting said method into practice.

### FIELD OF THE INVENTION

The present application is directed to a method that allows supercooling water, water solutions, animal and vegetal tissues and organs and other liquids without freezing them. That is, cooling the liquid at a temperature below that of its nominal freezing-melting point, without freezing. The invention also includes an apparatus for performing such supercooling and further methods where supercooling without formation of crystals is advantageous.

### BACKGROUND

Controlling freezing of water is of general interest for science with many technical applications strongly affecting our lives. In spite the fact bulk water can be supercooled down to temperatures well below 0° C. before it homogeneously freezes, inhomogeneous freezing of water is triggered on the surface at much higher temperatures (Hindmarsh, J., Russell, A. & Chen, X. Experimental and numerical analysis of the temperature transition of a suspended freezing water droplet. . . . J. Heat Mass Transf. 46, 1199-1213 (2003)).

The use of cooling for preservation of organic materials, food and perishable goods is a well-known technique. It is known that the lower the temperature is, the longer the time the product can be stored without a significant damage. The limit for cooling down fresh produces is just freezing. Ice crystals break the cellular structure, denaturalize and spoil the product. Most of the refrigerated chambers for fresh produces are designed to be above 0° C., typically between 4 and 5° C., to safely prevent occasional freezing.

Controlling surface crystallization of liquids, e.g. water, is of key importance and can lead to applications in many fields such as preservation of organic material, chemical catalysis or aerospace.

### BRIEF DESCRIPTION OF THE FIGURES

FIG. 1: Temperature of freezing (melting point or freezing point) of a 2.8 mm diameter deionized water droplet vs. relative humidity in still air.

FIG. 2: Sequence of images of water droplets freezing at different temperature and relative humidity conditions.

### BRIEF DESCRIPTION OF THE INVENTION

Contrary to current scientific understanding we have experimentally shown that freezing nucleated on the surface of a water droplet is strongly depressed by dryness in air.

Thus, a first aspect of the invention is a method for modulating freezing of a liquid substance, said liquid substance being in the presence of a gas phase, the method comprising modulating the temperature of the liquid, of the gas phase or of a combination thereof, and controlling the amount of vapor of the substance present in the gas phase, that is the percentage of saturation.

Said substance is typically water or an aqueous solution, although the present invention can be applied to other liquids or mixtures of liquids, or water forming part of a material such as biological material. Thus, the scope of the invention includes a method for modulating freezing (preferably, for preventing freezing) of water in a material such as biological material, said biological material being in the presence of a gas phase, the method comprising modulating the temperature of the biological material, of the gas phase or of a combination thereof, and controlling the amount of water vapor present in the gas phase, that is the percentage of saturation. The percentage of saturation a relative humidity are equivalent terms in the case of the substance being water.

So far it has been commonly assumed that dryness in air enhances evaporation on the surface, cooling the surface and making freezing more likely to occur at higher temperatures. See for example Satoh, I., Fushinobu, K. & Hashimoto, Y. Freezing of a water droplet due to evaporation—heat transfer dominating the evaporation—freezing phenomena and the effect of boiling on freezing characteristics. Int. J. Refrig. 25, 226-234 (2002). The present invention provides proof that it is the opposite which is true, opening the door of new applications.

A further aspect of the invention is an apparatus for modulating freezing of a liquid substance, said liquid substance being in the presence of a vapor phase, the apparatus comprising a chamber adapted to receive said liquid substance, means for controlling the temperature of the liquid substance, of the vapor phase or of both, and means for controlling the concentration of the substance present in the vapor phase. Such apparatus is extremely useful for preservation of biological material.

A further aspect is the use of means to control the concentration of a substance in a vapor phase to modulate freezing of a liquid of said substance, said liquid substance being in contact with the vapor phase.

### DETAILED DESCRIPTION OF THE INVENTION

Definitions

Relative Humidity in a vapor phase is the ratio of the partial pressure of water vapor to the equilibrium vapor pressure of water at the same temperature. Also in the present invention humidity may be used to refer to the concentration in the vapor phase of substances other than water.

Cooling is understood as decreasing the temperature of the environment, whether of the liquid, of a material comprising said liquid (e.g. biological material comprising water), the vapor phase present in the system or a combination of the foregoing.

Freezing point is defined herein as the actual point on the temperature-humidity diagram for which a liquid turns into solid, e.g. where water turns into ice.

Nominal freezing point is the maximum temperature at which the liquid freezes. It is always that at which the solid phase melts at atmospheric pressure. In the case of water at atmospheric pressure it is 0° C. (close to the triple point of water).

To supercool a liquid is to cool that liquid down to a temperature below the nominal freezing point of such a liquid without a substantial formation of solid crystals.

Gas phase is understood as the gaseous phase in contact with the liquid. Said gas phase can be limited to pure vapor of one or several substances present in the liquid (e.g. water) or in the material comprising said liquid, or it can be a more complex mixture with further components, such as those found in air (e.g. nitrogen, oxygen, CO, CO₂).

The method of the Invention

Besides shedding light on a number of water-related phenomena such as the Mpemba effect (Mpemba, E B y Osborne, D. G. cool? Phys. Educ. 14, 410-413 (1979)), the present invention opens new perspectives in many technical fields, especially in reference to water.

A further aspect of the invention is a method for cooling without freezing liquids which are in contact with air, characterized by employing cooling means for cooling the air, the liquid or both, preferably both; while maintaining in the gaseous phase a humidity sufficiently low through the use of desiccation means. A further aspect is a method for freezing liquids characterized by cooling using cooling means while maintaining a low humidity and characterized also by using afterwards humidification methods to induce freezing. A further aspect is a method for the modulation, acceleration or deceleration of the freezing of a liquid solution in the presence of a gaseous phase characterized by controlling the vapor present in the gaseous phase. Still a further aspect is a method for preserving perishable aqueous liquids or products (e.g. a biological material), consisting on controlling the vapor in the gaseous phase making the freezing temperature as low as possible and cooling said liquids of products as much as possible without freezing.

Water has always attracted a great interest due to its omnipresence and importance in human activity but also to the number of its anomalies like the existence of High density and Low density “structures” of supercooled liquid water. But, if bulk liquids have a number of counterintuitive, exciting and decisive properties; their surface seems to be a prodigious source of surprises and presents distinct characteristic properties different from those of bulk materials (Perez-Diaz, J. & Munoz, M. Spin-polarized electrons at interfaces: Co/Cu systems. Phys. Rev. B 50,8824-8831 (1994)).

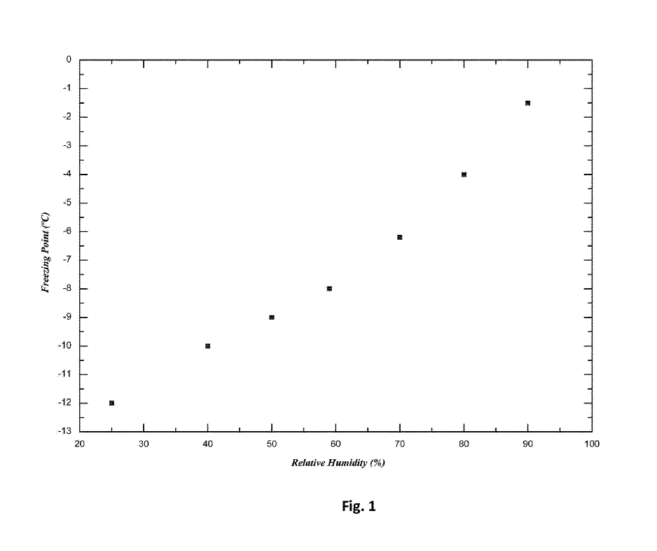

We have found that when cooling down a liquid comprising a substance (or the pure liquid substance, e.g. water) in the presence of a gas phase partially containing vapor of the substance, surprisingly the temperature at which the liquid substance starts to develop crystals, and thus starts to solidify or freeze, depends on the concentration of said substance in the vapor phase. The lower the concentration of vapor of the substance in the gas phase, the lower the temperature at which crystallization is triggered. According to an embodiment, the present invention also encompasses the lowest end of concentration range where the concentration of vapor of the substance in the gas phase is 0. According to another embodiment, the invention also comprises a method where the liquid comprising a substance (or the pure liquid component, e.g. water) is place under vacuum. In the case of water, this means that in still air at constant relative humidity conditions we have found that the lower relative humidity is, the lower the temperature at which it freezes (FIG. 1). Thus, we could say that dryness “prevents” freezing of water. This result is the opposite of current scientific belief.

The liquid substance can be any liquid. Non-limitative examples are water, alcohols (e.g. methanol, ethanol, etc) or other organic solvents (ether, methyl ester acetate), whether they are pure (i.e. the component is essentially the liquid) or in mixtures (e.g. a mixture of methanol and water or water wherein salts or biological molecules are dissolved).

This is very useful to design methods and apparatus capable of performing controlled supercooling (cooling the liquid substance at temperatures below those corresponding to the nominal freezing point at a given pressure without observing freezing), or of freezing liquid substances, by modifying the relative concentration of the substance in the gas phase with which the liquid substance is in contact, without changing other variables, such as temperature. That is, freezing or preventing freezing of the liquid substance by only changing the concentration of said substance in the gas phase, while maintaining all other variables constant, including pressure and temperature. Once the relation between the concentration of vapor of substance in the gas phase and the freezing point of the liquid substance comprising said component is stablished, one can supercool the liquid substance without freezing or induce freezing by changing the concentration of vapor of the substance in the gas phase. Such relationship can be plotted by measuring the freezing point of the liquid substance at different concentrations of the substance in the gas phase (see FIG. 1). First, the chamber is kept at a temperature above the nominal freezing point and at a selected humidity. The sample, for example a liquid substance pending droplet is then provided. It quickly reaches a thermal equilibrium with the air in the chamber. Then, cooling means, for example Peltier coolers, are used to slowly cool down the air in the chamber. Humidity is kept constant by using dehumidification means. A camera can be used to watch the state of the sample. For example if the sample is illuminated from the back, the transmitted light drastically changes when freezing is triggered as there is a sudden change in the refraction index.

Alternatively the sample can be supercooled at low humidity as described above, but before reaching the freezing point, humidity can be increased up to the point at which freezing is triggered. Both methods provide essentially the same set of points in the Temperature-humidity diagram. So, for constant temperature and pressure, for example, as it can be seen in FIG. 1, at −8° C. a water droplet remains liquid whenever humidity is lower than 60%. It freezes when humidity is higher than that. We can thus control at a given temperature and pressure whether a liquid substance freezes.

Thus, another aspect of the invention is a method for cooling without freezing at least one substance present in a liquid, said liquid being in the presence of a gas phase, the method comprising reducing the temperature of the liquid, of the gas phase or a combination thereof, and controlling the concentration of the substance present in the gas phase thereby preventing freezing of the liquid, which comprises the substance. Such control is possible, for example, once the relationship between the concentration of a substance in the vapor phase and the freezing point of the liquid comprising said substance is established, for example, by means of a plot as explained above.

The present invention is also useful to freeze under controlled conditions, and is therefore another aspect of the invention a method for freezing a liquid substance, said liquid substance being in the presence of a vapor phase, comprising the steps of (i) cooling the liquid substance, the vapor phase or a combination thereof, down to a temperature below the nominal freezing point and controlling the amount of the substance present in the vapor phase thereby preventing freezing of the liquid substance; (ii) raising the amount of the substance present in the vapor phase thereby inducing freezing of the liquid substance.

The present invention thus provides for the first time the use of means to control the amount of a substance present in a vapor phase to modulate freezing of a supercooled liquid comprising said substance, which is in the presence of said vapor phase. This is especially useful in the case of water, where desiccating or humidifying means (or both) can be used for modulating freezing of water or of a material comprising water, e.g. biological material.

An exemplary application of the above supercooling method can be found in the preservation of biological material. It is a further aspect of the invention to provide a method for preserving a liquid or a material comprising the liquid which need to be preserved, the liquid comprising a substance and being in the presence of a gas phase, the method comprising cooling the liquid substance or the material comprising said liquid substance, the gas phase or a combination of the foregoing, and controlling the concentration of the substance in the gas phase thereby preventing freezing of the liquid substance and thus of the material. Such biological material can be a microorganism, a cell culture, organic tissue, natural or synthetic, or an organ or an organism or part of it. The method would include a step in which the biological material is cooled to a temperature while controlling relative humidity so as to prevent freezing of the biological material. This allows cooling below 0° C. without frost. The biological material can thus be preserved for much longer times, as the rate of the reactions, metabolism and microbial activity which cause decay decreases exponentially with temperature. When required, the method includes a second step were the temperature of the biological material is raised while maintaining a control over relative humidity in order to prevent or induce freezing, depending on the intended specific application.

According to a preferred embodiment, said material is biological material, including organisms and parts thereof, for example, one selected from the group consisting of a microorganism, a cell culture, organic tissue, natural or synthetic, and organs. Said biological material can also include food and brewages, such as vegetables, meat, fish, fruit, juices, drinks and mixtures thereof, or other vegetables such as flowers.

According to a further embodiment, the liquid is water or a material comprising water, and it is cooled to a cooling temperature below 0° C. at atmospheric pressure. Said temperature is preferably comprised between −20° C. and 0° C., preferably between −15° C. and 0° C. When freezing is to be prevented, the concentration of water in the vapor phase is typically kept below 50%, preferably between 0% and 50%, more preferably between 5% and 40%, more preferably between 7% and 30%, even more preferably between 10 and 30%.

### The Apparatus of the Invention

For example, in the case of an organ, preservation can be extended from a few hours to days, significantly improving current technology. It is thus a further aspect of the invention an apparatus for modulating freezing of a liquid substance, said liquid substance being in the presence of a gas phase, the apparatus comprising a chamber adapted to receive said liquid substance, means for controlling the temperature of the liquid substance, of the vapor phase or a combination thereof, and means for controlling the amount of the substance present in the vapor phase. Such an apparatus can be used to preserve any kind of material, such as biological material, preferably and organ, more preferably a heart.

Means to control temperature and pressure may be used and are known to the skilled person. Any of them are useful to the present invention as long as they allow suitable control. Means used to control temperature include, for example, Peltier devices. Such means must be capable of bringing temperatures down to supercooling temperatures, for example, in the case of water, below 0° C.

Such apparatus can be configured to supercool other biological samples, for example, one selected from the group consisting of a microorganism, a cell culture, organic tissue, natural or synthetic organs, and food and brewages, such as vegetables, meat, fish, fruit, juices, drinks and mixtures thereof, or other vegetables such as flowers. The apparatus of the invention can thus have any size and shape without limitation. Thus, according to an embodiment of the invention, the apparatus comprises a chamber to receive the organ (e.g. heart) and means for controlling the temperature of the heart, of the vapor phase (mainly water) or of both, and means for controlling humidity in the vapor phase.

### EXAMPLES

We designed and built an isothermal chamber where it is possible to keep a liquid droplet at a fixed temperature and a fixed humidity for the air at atmospheric pressure. This chamber was made of aluminum and provided with Peltier devices with their cold face cooling down the walls of the chamber. Moreover, it was thermally isolated and was provided with two optical windows for illumination and observation.

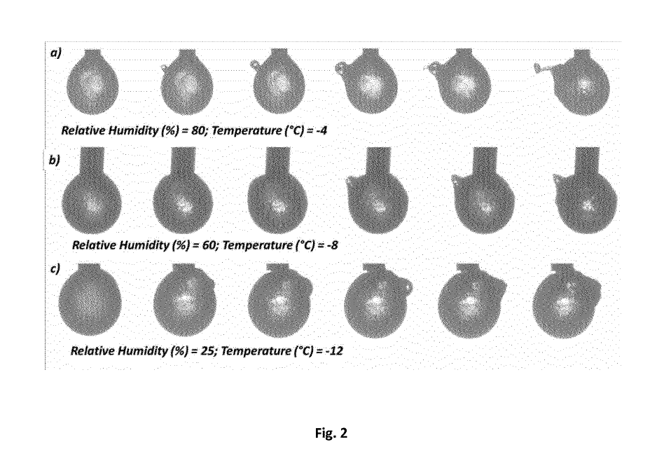

We used a camera to sequence the freezing process in different conditions of humidity. First, freezing of the surface occurs, preventing light from the back to reach the camera. The freezing frontwave progression all along the surface of the droplet is faster than the time between frames (15 ms). Once the surface is frozen it makes up a sort of rigid shell still containing liquid supercooled water in it. Then the progression of the freezing frontwave inwards compresses the liquid water which eventually breaks out through the weakest point of the shell. This generates protruding icicles as can be seen in FIG. 2. The size and shape of these protruding icicles strongly depends on the humidity of air as it can be seen in FIG. 2. For low humidity, the freezing temperature is also low and there are only protruding deformations. For medium humidity the protuberances become conic and even present a final point. Finally, for high humidity, the freezing temperature approaches 0° C. and icicles protrude forming stable cylindrical shells in which liquid water is contained and flows to the tip where they grow. This way of growing requires the existence of a liquid tip and a simultaneous axial progression of the freezing wavefront all around the cylinder.

1. A method for modulating freezing of a liquid substance, said liquid substance being in the presence of a gas phase, the method comprising modulating the temperature of the liquid substance, of the vapor phase or of both, and controlling the concentration of vapor of said substance present in the gas phase.

2. The method according to claim 1 for supercooling a liquid without freezing it, said liquid being in the presence of a gas phase, the method comprising reducing the temperature of the liquid, of the gas phase or both, and controlling the concentration of vapor of the substance present in the gas phase thereby preventing freezing of the liquid substance.

3. The method according to claim 1 for freezing a liquid substance, said liquid substance being in the presence of a gas phase, comprising the steps of (i) cooling the liquid substance, the gas phase or both, down to a temperature below the nominal freezing point of the liquid substance and controlling the concentration of vapor of the substance present in the gas phase thereby preventing freezing of the liquid substance; (ii) rising the amount of vapor of the substance present in the gas phase thereby inducing freezing.

4. The method of claim 1 or 2 for preserving a liquid substance which needs to be preserved, the liquid substance being in the presence of a gas phase, the method comprising cooling the liquid substance, the gas phase or a combination of the foregoing, and reducing the amount of vapor of the substance in the gas phase thereby preventing freezing of the substance.

5. The method for preserving of claim 4 comprising the additional step of heating the liquid substance and/or the vapor phase and controlling the concentration of the substance in the vapor phase thereby preventing freezing of the substance.

6. The method according to any of the previous claims, wherein the ratio between temperature and concentration of vapor of the substance in the gas phase is kept within a pre-determined relationship thereby preventing freezing of the liquid substance.

7. The method according to any of the previous claims wherein said liquid substance is water.

8. The method according to claim 7, wherein the water, the gas phase or a combination of both is cooled to a temperature below 0° C. at atmospheric pressure.

9. The method according to claim 8, wherein the cooling temperature is comprised between −20° C. and 0° C.

10. The method according to any of claims 7 to 8, wherein the concentration of water in the vapor phase is kept below 50%.

11. The method of any of the previous claims for modulating freezing of a liquid substance in a material that comprises said liquid.

12. The method according to claim 8 wherein said liquid is water and said material is biological material selected from the group consisting of an organism, preferably a microorganism or a cell culture, organic tissue, natural or synthetic, organs, groups of organs, and systems.

13. An apparatus for modulating freezing of a liquid substance, said liquid being in the presence of a gas phase, the apparatus comprising a chamber adapted to receive said liquid substance, means for controlling the temperature of the liquid or of a material containing said liquid, of the gas phase or of both, and which is capable of bringing the temperature below the nominal freezing point of the liquid, and means for controlling the concentration of the substance present in the gas phase.

14. The apparatus according to claim 13, wherein said liquid substance is in a material, and is water, said material being a biological material selected from the group consisting of an organism, preferably a microorganism or a cell culture, organic tissue, natural or synthetic, organs, groups of organs, and systems.

15. The apparatus according to claim 14, wherein the biological material is a heart.

16. Use of means to control the concentration of vapor of a substance in a gas phase to modulate freezing of a supercooled liquid of said substance, said liquid substance being in contact with the gas phase.

17. The use according to claim 16, wherein the liquid substance is water and said means to control the concentration of vapor of water in a gas phase are desiccating means or humidifying means or both.
